(19) United States
(12) Patent Application Publication
(10) Pub. No.: US 2016/0318616 A1
(43) Pub. Date: Nov. 3, 2016

(54) FLIGHT RECORDER WITH REDUNDANT EJECTABLE FLIGHT DATA MEMORY MODULES

(71) Applicant: NORTHROP GRUMMAN LITEF GMBH, Freiburg (DE)

(72) Inventor: HARALD FISCHER, FREIBURG (DE)

(73) Assignee: Northrop Grumman Litef GMBH, Freiburg (DE)

(21) Appl. No.: 15/106,076

(22) PCT Filed: Dec. 5, 2014
(86) PCT No.: PCT/EP2014/003265

§ 371 Date: Jun. 17, 2016

(30) Foreign Application Priority Data
Dec. 18, 2013 (DE) 10 2013 021 500.5

(51) Int. Cl. B64D 25/20; G06F 1/18; G06F 12/14; B64D 45/00

(52) U.S. Cl. CPC B64D 25/20; B64D 45/00; G06F 1/181; G06F 12/1408; B64D 2045/0065; G06F 2212/1052

(57) ABSTRACT

A flight data memory module (1) has a data memory device (2) for storing data, a data receiver device (3, 4) for receiving the data and a sheath (8) enclosing the data memory device (2). The sheath (8) has a spherical, ellipsoid, ovoid and/or rounded convex wall. A flight data memory device (11) has a plurality of flight data memory modules (1), a receptacle for arranging the plurality of flight data memory modules (1) in and/or on an aircraft and an ejector device (12) for mechanically ejecting the flight data memory modules (1). A flight data storage system (10) has a flight data memory device (11), a data-collecting device (16) for collecting data in a flight data system (17) and a data-transmitting device (15) for transmitting the data collected by the data-collecting device (16) to at least one of the flight data memory modules (1).

The invention concerns a flight data memory module for storing flight data during the flight of an aircraft, for example of a passenger, transport or military aircraft. The invention concerns further a flight data memory device, a flight data storage system and a method for storing flight data.

Recording devices that are carried on board of an aircraft in order to store relevant flight data and aircraft parameters during a flight are denominated flight recorder, flight data recorder or colloquial “black box”. Recording allows reconstructing the most important events and parameters after a flight accident in order to reconstruct the circumstances of the accident. The flight recorder is constructed such that the stored data remain as intact and readable as possible also in case of high impact velocities, high temperatures, or high water pressure.

From military aviation so called ejectable flight data recorder are known that can be ejected before the impact, for example during unlocking of an ejector seat. The goal is to save the flight data recorder from destruction during impact of the aircraft with high velocity and from a possible explosion of the armament.

Search and recovery of flight recorders after accidents, for example over the sea, is connected, however, with considerable effort and remains occasionally without success, as it is not always possible to find and/or to recover the flight recorder.

The object of the invention is to provide a flight data memory module, a flight data memory device, a system for flight data storage and a method for storing flight data that allow further improvement of securing and recovering of the relevant data.

This object is solved by a flight data memory module, a flight data memory device, a flight data storage system and a method for storing flight data according to the independent claims. Further embodiments are defined in the dependent claims.

A flight data memory module comprises a data memory device for storing data, a data receiver device for receiving the data and a sheath enclosing the data memory device, wherein the flight data memory module has a total weight of less or equal to 200 g.

The data memory device may also comprise an arbitrary electronic storage element that allows electronic storing and for example read-out of the data at a later time. The data memory device may be readable and writable several times and may allow data storage that is for example indexed with a continuous system time and/or real time. The data memory device may also be organized as ring buffer. For example it may be ensured that all data which are stored within a predetermined time period of e.g. 15 or 30 minutes previous to a present time or a present storing process are retrievably stored in the data memory device and are not overwritten, while older data may be overwritten.

A plurality of data having different format and content may be recorded in the data memory device. For example, it is possible to store data that can reproduce flight or aircraft parameters such as height, velocity, route, pitch, aileron and/or flap position, throttle lever position, as well as engine parameters. Further, sounds and voices may be recorded, for example radio telephone traffic from and/or to the cockpit, background noise in the cockpit, sound records of each arbitrary microphone, conversations of members of the flight crew, acoustic fault indications, and announcements of members of the flight crew, for example via the cabinet loudspeaker system. Storing of data in the data memory device may be executed according to the respectively appropriate standards or safety regulations.

The data receiver device may form an interface to the flight data memory module via which the data to be recorded are transferred into the flight data memory module. It may be formed via a plug or contact connection, but may also be formed wirelessly for example as nearfield communication (NFC) interface and may comprise e.g. a (sending and/or receiving) antenna.

The sheath encompassing the data memory device encapsulates the data memory device and saves, thus, the stored data or the electric data storage from outer influences, for example from an impact, moisture, radiation and further influences. The flight data memory module is hence suitable for saving the stored data from damaging environmental influences until they are read-out.

The construction of the flight data memory module with a total weight of less or equal to 200 g results in a small and lightweight flight data memory module. Such a flight data memory module may be provided e.g. redundantly on the aircraft and may be ejected at any time without danger for humans and the environment. Because of its small mass it is only exposed to small impact energies during impact. Consequently, it is possible to eject such flight data memory modules as needed at any time and without danger, in case of redundantly provided flight data memory modules also several times, if necessary.

According to a further embodiment the sheath may have a maxima diameter of less or equal to 20 cm, for example even less or equal to 5 cm. The flight data memory module may also have a total mass of less or equal to 200 g, in particular of less than 100 g, 50 g or 25 g. The data memory module may have a capacity of less or equal to 512 gigabyte, for example even of less or equal to 64 gigabyte. Further, the sheath may comprise a spherical, ellipsoid, ovoid, or rounded convex wall and the wall may be formed from a metal or a plastic material, and/or may be at least partially signal colored.

Providing a sheath with a maximal diameter of less or equal to 20 cm, for example of less or equal to 5 cm or even 4 cm allows providing a flight data memory module having dimensions that correspond approximately to that of a ping pong ball. Also, the construction of the flight data memory module having a total weight of less or equal to 100 g, 50 g, 25 g or even 10 g leads to a small and lightweight flight data memory module. Such a flight data memory module may be ejected at any time without danger for humans and the environment.

Providing a data memory module having a capacity of less or equal to 512 gigabyte, for example less or equal to 64 gigabyte, allows cost efficient design of the data memory device. At the same time, a sufficient storage volume for the most important data to be stored is provided. Consequently, the flight data memory module can be manufactured cost efficient and can for example be provided redundantly on the aircraft.

Forming the sheath as spherical, ellipsoid, ovoid, i.e. irregular egg formed rounded convex wall, if necessary, allows, e.g. obtaining a flight data memory module being lightweight and having small dimensions that has, nevertheless, highest possible stability, for example for protection of the data memory device during an impact.

The sheath may for example be formed of metal or a plastic material such that predetermined impact characteristics can be endured without negative influences to the data memory device (e.g. data loss). In addition, it is possible to fix the data memory device elastically, for example by means of damping means, to the sheath, e.g. by a rubber coating (inside or outside)) in order to protect it from the effects of an impact.

Providing an at least partially signal colored wall, for example in red, orange, and/or yellow, e.g. with fluorescent or reflective optical effect, may simplify finding the flight data memory module after ejection or after a crash.

Further, an, e.g. multi-language, imprint or a pictogram may be imprinted, which requests a finder to hand over a found flight data memory module, e.g. immediately, to the responsible authority or to inform this authority.

According to this embodiment, the flight data memory module can be formed small, lightweight, compact, and robust. It is ensured that it does not cause serious damages after an ejection and that the memory device is protected from the effects of the impact. Further, the flight data memory module may be made floatable by the sheath enclosing the data memory module, which simplifies finding of the device, for example after a flight accident over the sea. An accordingly formed flight data memory module can also be manufactured cost efficient and may be used redundantly. For example, it is not absolutely necessary to form such a flight data memory module completely fireproof, since it can be assumed that at least some of the, in this case, several flight data memory modules survive the accident undamaged or in a state that allows read-out because of their redundancy.

According to a further embodiment the data receiver device may be designed to receive data wirelessly. In addition or alternatively in this embodiment the sheath may also enclose the data receiver device.

Providing a data receiver device for wireless transfer of data allows simple data transfer, e.g. via nearfield communication, for example according to the known communication protocols and systems (e.g. WLAN, Bluetooth, NFC). By this means, data may for example be transferred substantially simultaneously to all or several flight data memory modules and may be stored in the respective data memory devices. To this end, no mechanical contact or plug connection is necessary that might for example hinder an ejection of the flight data memory module.

According to a further embodiment, the flight data memory module may comprise a signal sending device configured to send a localization signal.

For example, the signal sending device may send a signal, which is suitable for an air and/or water localization, after recurring periods, for example every three or four hours or also after longer or shorter time periods, e.g. every thirty minutes. The signal sending device may for example be formed as emergency position indicating radio beacon or radio transmitter. It may be activated automatically for example during ejection or after water contact and send an alarm signal on one or several standard emergency frequencies, which may for example be transferred via a satellite communication and/or ground stations to the respective rescue coordination centers. This allows fast sending of rescue forces to the place of ejection or of the assumed accident and allows further a simple and cost efficient localization of the flight data memory module.

According to a further embodiment the flight data memory module may comprise an electric energy storage, which is configured to supply electric energy to the data receiver device, the data memory device and/or the signal sending device. Further, the flight data memory module may comprise a charging device for example for wireless and/or wire bound charging of the electric energy storage with electric energy.

The electric energy storage ensures that the components of the flight data memory module and in particular the signal sending device have a sufficient amount of energy, which allows for example to send the localization signal during a predetermined time period periodically, also after ejection of the flight data memory module. Further, the electric energy storage may also be used before ejection to supply electric energy to the data receiver device and a possibly comprised processor.

The charging device may be arranged before ejection, for example in a surrounding of the flight data memory module and may charge the electric energy storage periodically or permanently. The charge may for example be transferred wirelessly, in particular inductively. Alternatively, an easily detachable contact or plug connection may be provided, which allows charging of the electric energy storage with a high efficiency and which does at the same time not impede an injection of the flight data memory module.

A flight data memory device comprises a plurality of flight data memory modules, each having a data memory device for storing data, a data receiver device for receiving the data and a sheath enclosing the data memory device. Further, the flight data memory device comprises a receptacle, e.g. a container for arranging the plurality of flight data memory modules in and/or on an aircraft. Further, the flight data memory device comprises an ejection device arranged on the receptacle or the container for mechanically ejecting of at least a part of the plurality of flight data memory modules.

The flight data memory device can therefore be equipped with a plurality of flight data memory modules, for example with five, ten, or more flight data memory modules. This redundant design is possible, as according to the described embodiments the flight data memory modules can be provided cost efficient. Further, this redundant design provides enhanced security, as not only a single flight recorder is provided, but several flight data memory modules on each of which the relevant data are stored. In particular, a single flight recorder is more endangered by total destruction or loss than a plurality of flight data memory modules, as at least finding of a single flight data memory module makes the relevant data available.

The container (also called receptacle) allows arranging the plurality of flight data memory modules in or on the aircraft, for example during a flight, safely but at any time ready for ejection. Further, the container may comprise the necessary communication technique to supply the data to be stored in the respective flight data memory module for example to the respective data receiver devices. Moreover, it is possible to provide for example one or several charging apparatus(es) as counterpart(s) to the charging devices of the flight data memory modules.

The ejection device arranged on the receptacle or the container may for example comprise a flap mechanism or a flap which can be operated easily and quickly and which opens the container during operation such that the flight data memory modules can be ejected or drop out. In addition, the ejecting device may comprise further ejection mechanisms that allow for example quick releasing of possible plug connections for data communication or for electric charging, if necessary.

According to an embodiment the flight data memory device comprises a plurality of flight data memory modules according to one of the previously described embodiments.

A flight data storage system comprises a flight data memory device according to one of the previously described embodiments. Further, the system comprises a data collecting device for collecting data in a flight data system of the aircraft and a data transmitting device for transmitting the data collected by the data collecting device to the data receiver device of at least one of the plurality of flight data memory modules.

The flight data memory device may be arranged in or on the aircraft for example such that an ejection of the plurality of flight data memory modules by the ejection device is easy.

The data collecting device may be formed such that it records, intercepts or taps data exchange, e.g. between the aircraft systems, for example in a communication network internal to the aircraft. Further, the data collecting device may alternatively or additionally record data exchange between the existent systems and an existent, for example conventional, flight recorder, which may be installed in the aircraft according to the conventional regulations.

In this process, the data may be intercepted or recorded interference-free such that neither an interference in the data exchange between the existing aircraft systems nor interference in the data exchange between the aircraft systems and the existent flight recorder has to be feared. In this manner, the data to be recorded can be collected interference-free and without influence on security and functioning of the aircraft controls and on recording in the existing flight recorder.

The data transmitting device of the flight data storage system serves as counterpart to the respective data collecting device of the plurality of flight data memory modules. In the data transmitting device the collected data can be formatted and/or encrypted, indexed for storing (for example in a ring buffer process), and transmitted to the flight data memory modules or their data receiver devices. As already described the data transmission may be carried out wirelessly by nearfield communication or via an easily resolvable contact and/or plug connection. In this manner, the data transmitting device centrally controls the data transmission to the plurality of flight data memory modules, for example to each of the flight data memory modules, and ensures, in this manner, formatting, encrypting, and storing of the relevant flight data that are to be stored redundantly.

According to an embodiment of the system an ejection decision device for generating an ejection instruction for mechanically ejecting the at least one part of the plurality of flight data memory modules by the ejection device may be provided.

The ejection decision device controls, hence, centrally the ejection of the flight data memory modules and decides about the time of ejection and the number of flight data memory modules to be ejected. For example, several flight data memory modules may be ejected simultaneously such that finding of at least one of the ejected data memory modules is probable. Further, it is possible to eject flight data memory modules several times at different consecutive times. The repeated ejection at different times enhances the probability for finding at least a single flight data memory module. Further, relevant data that have been collected e.g. shortly before an accident in the system can still be recorded on remaining flight data memory modules without the risk that all flight data memory modules are destroyed due to a delayed ejection.

According to a further embodiment the ejection decision device generates the ejection instruction depending on a previously determined ejection criterion. The ejection criterion may be evaluated on the basis of at least one information selected from a group comprising a date collected by the data collecting device, a trigger request given by a pilot, copilot and/or flight attendant, information concerning failure of a subsystem of the aircraft, information concerning a loss of height of the aircraft, and information concerning an emergency measure initiated by a pilot, copilot, or flight attendant, and further data of the flight data system.

The ejection decision device can therefore ensure a timely or early ejection of at least a part of the flight data memory modules for example in case of danger. In this process, ejection may be triggered by different signals or by the occurrence of different information.

In particular, the data collected by the data collecting device are provided in the system, which may comprise all or at least a main part of the security relevant data. These may for example be forwarded from the data collecting device to the ejection decision device, which evaluates them according to the ejection criterion. This allows for example an automatic ejection decision of the system, e.g. based on at least a date (of an information unit) of the data collected by the data collecting device.

Further, it is possible to take an ejection decision based on a trigger request of an operator, for example of a pilot, copilot and/or flight attendant. This corresponds to a manual trigger which is based for example on a human evaluation of a case of danger that is possibly not known to the system yet. As an example threatening of passengers or of the crew by a hijacker is conceivable. To input the trigger request suitable input means, e.g. a button or a lever, have to be provided.

Further, it is possible to evaluate information concerning an instable attitude of the aircraft, which may be recognized for example by attitude sensors of the aircraft and/or by attitude sensors of the flight data storage system. In particular, an own attitude sensor of the flight data storage system can provide indications about an instable attitude, if the aircraft internal network for data communication shows erroneous functions, e.g. if it is blocked by a high number of error messages. Also then it can be decided that at least a part of the flight data memory modules has to be ejected.

An according decision may also be taken on the basis of information concerning failure of a subsystem of the aircraft, for example of an engine, a flap, or an elevator.

Moreover, it is possible to monitor also the altitude of the aircraft in order to make the ejection decision in case of quick loss of height.

Also information concerning emergency measures initiated by the pilot, copilot, or flight attendant as for example showing an according indication for passengers of the aircraft or releasing the flaps of the oxygen provision for the passengers may be used to make an ejection decision.

Moreover, also arbitrary further information of the flight data system may be used as basis for the ejection decision, even if they are not collected for transfer to the flight data memory modules, but are recorded or measured from the aircraft internal system for data communication.

Further, ejection of some or of a part of the flight data modules may be recorded. For example, time and place of ejection may e.g. be determined based on a time and positioning signal (e.g. GPS) present in the system and may for example be stored in the remaining flight data memory modules. This allows a later reconstruction of the ejection history and possibly of the circumstances of the accident. Based on this, from a found flight data memory module information about previously ejected flight data memory modules can be read out such that the previously ejected flight data memory modules may be localized more easily. These may, e.g. because of the ring buffer principle, comprise further data, e.g. from a previous phase of the accident, which can contribute to the reconstruction of the circumstances of the accident.

According to a further embodiment of the system an encrypting device for encrypting the data collected by the data collecting device, which are to be transmitted to the data receiver device of the at least one of the plurality of flight data memory modules may be provided.

The encrypting device allows central encryption of the data to be stored in the redundant flight data memory modules at first. The data stored in the flight data memory modules can, hence, only be decoded or evaluated by authorized persons. Misuse of the ejected flight data memory modules or of the data stored thereon is hence not to be expected.

A method for storing flight data comprises collecting of data in a flight data system of an aircraft as well as transmitting the collected data to a data receiver device of at least one of a plurality of flight data memory modules, wherein the flight data memory modules are arranged in a receptacle or a container in and/or on the aircraft. Further, the method comprises mechanically ejecting of at least a part of the plurality of flight data memory modules by an ejection device arranged on the container/receptacle based on an ejection instruction that depends on a predetermined ejection criterion.

The method for storing of flight data may for example be carried out by means of an arbitrary embodiment of the previously described flight data memory module, the previously described flight data memory device and/or the previously described flight data storage system. All of the previously described features may also be used functionally in the method for storing flight data and may be implemented method like.

These and further features of the invention will be described in detail according to examples by means of the accompanying figures. It shows:

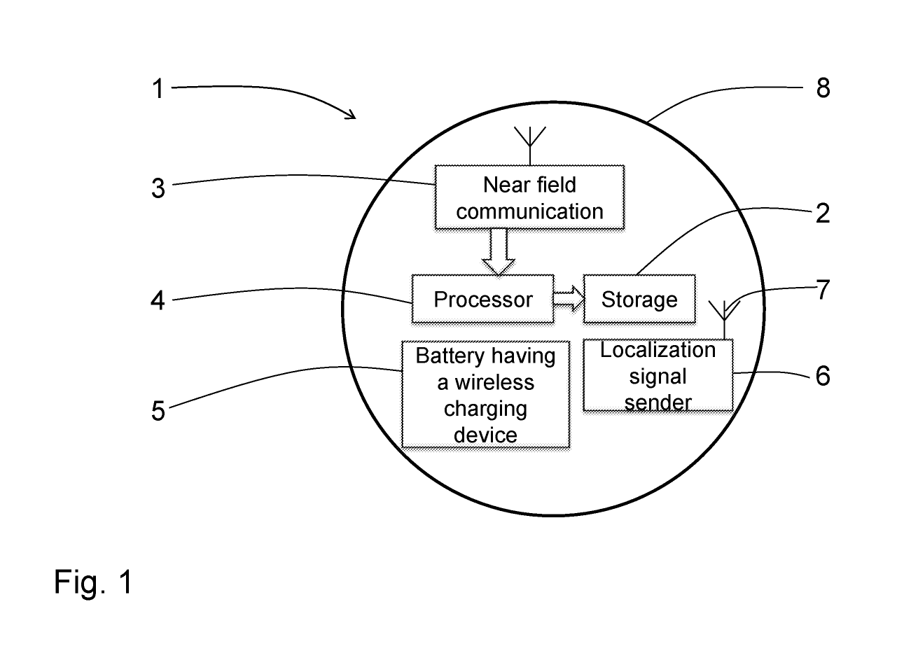

FIG. 1 an embodiment of a flight data memory module, and

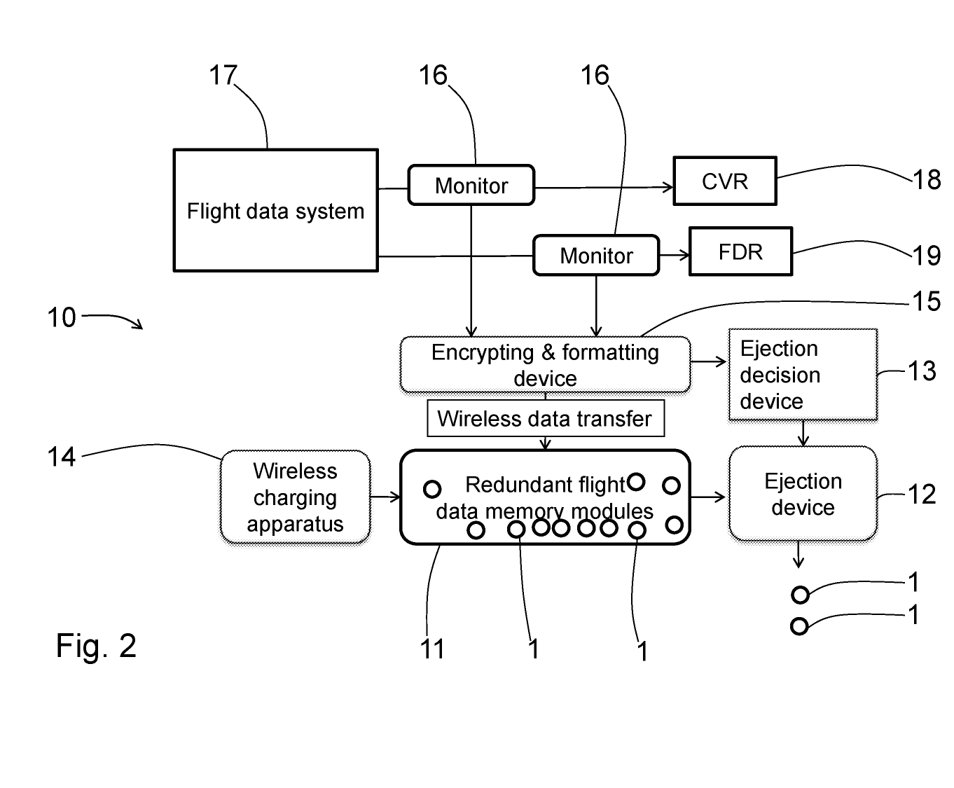

FIG. 2 an embodiment of a flight data storage system.

The embodiments shown in the figures are illustrated schematically and illustrate examples. The components are not necessarily illustrated true-to-scale and may deviate in their respective size or scale from each other. The same reference signs designate the same or corresponding components.

FIG. 1 shows a flight data memory module 1 comprising a storage 2 for storing relevant flight data, for example relevant flight parameter or voice recordings as previously detailed, the evaluation of which may be of interest, for example after an aircraft accident. The data to be stored may be transmitted to the flight data memory module 1 by means of near field communication via a near field communication element 3 and may be stored in the storage 2. Receiving and storing of the data is controlled or monitored by a processor 4. Power supply of the electronic components of the flight data memory module is provided by a power supply element 5, which may for example comprise a battery and a charging device for wireless charging of the battery.

Further, the flight data memory module 1 may comprise optionally a localization signal sender 6, which may for example be able to send a localization signal, for example a radio signal, via a radio antenna 7 during a predetermined time period and after recurring time periods. The localization signal may for example be a signal for localization via a satellite localization system. Further, the localization signal may be a signal that can be transmitted through air or water. The localization signal sender 6 may, hence, correspond to an emergency position indicating radio beacon or to an “Emergency Locator Transmitter”.

The flight data memory module 1 may further comprise a sheath 8, which encloses the data memory device 2, and which encompasses or encapsulates the data memory device 2 in a kind of capsule. In this manner, the data memory device 2 can be protected after ejection from damaging environmental influences, that act in particular on the data storage, as for example wetness, radiation and mechanical influences. As described the sheath 8 may also encompass or encapsulate the further components of the flight data memory module 1, e.g. the nearfield communication element 3, the processor 4, the power supply element 5 and/or the localization signal sender 6.

According to the illustrated embodiment the sheath 8 comprises a substantially spherical wall that may for example be marked partially in a signal color. The sheath 8 may for example have a diameter of for example approximately 4 to 5 cm such that the flight data memory module has an outer appearance corresponding to a colored ping pong ball. The total weight can be small, for example less or equal to 25 g or even less or equal to 10 g such that no damages for humans or the environment have to be expected, if the flight data memory module is ejected in great heights from an aircraft. Due to the sheath 8 enclosing the flight data memory module, which has for example a water proof wall, the flight data memory module can be designed floatable, which simplifies localization after ejection over the sea. The flight data memory module 1 may also have other dimensions or another form.

The illustrated embodiment of the flight data memory module may therefore be manufactured or designed small, light-weight, compact, robust, floatable and cost-efficient. The flight data memory module 1 may hence be used redundantly in aircrafts and increases by its redundancy significantly the probability that flight data memory modules 1 are localized promptly and economically after an ejection or after an aircraft accident and can then be analyzed. Thus, cause studies for aircraft accidents can be carried out in an economic manner. If necessary, it is even possible that the emergency beacon function of the plurality of ejected flight data memory modules 1 supports localization of survivors. Further, due to the lightweight and spherical form, it is not to be expected that damages on ground can be caused by an ejection of the flight data memory module 1.

FIG. 2 shows a flight data storage system 10 comprising a flight data memory device 11, which comprises a container comprising flight data memory modules 1 arranged therein. An ejection device 12 for mechanically ejecting of at least an, e.g. predetermined, part of the plurality of flight data memory modules 1 is arranged on the container. The ejection device may for example comprise a flap mechanism in form of a flap which can be released quickly and easily.

The ejection device is controlled by an ejection decision device 13, wherein the ejection decision device 13 generates an ejection instruction for ejecting at least a part of the flight data memory modules 1 and is able to transmit it to the ejection device 12. For example, by means of an electric signal generated by the ejection decision device 13, the flap of the ejection device 12 may be opened.

Further, a charging apparatus 14 for wirelessly, for example inductive, charging of the power supply element 5 of the flight data memory modules 1 is provided on the container of the flight data memory device 11. This ensures that the battery of the power supply elements 5 has always and in particular in the moment of ejection a sufficient charge status to supply electric energy for generating the localization signal to the localization signal sender 6.

The flight data storage system 10 comprises further an encrypting and formatting device 15, which collects, encrypts, and formats the data to be stored on the flight data memory modules and which can control a wireless data transmission to the redundant flight data memory modules 1.

Further, data collecting devices 16 may be provided which collect data that are exchanged between a flight data system 17 of an aircraft, into which the flight data storage system 10 is integrated, and a cockpit voice recorder 18 (CVR) and a flight data recorder 19 (FDR). The collected data may be forwarded from the data collecting device 16 to the encrypting and formatting device 15.

In the illustrated flight data storage system 10, the redundant flight data memory modules 1 do therefore not replace the conventional flight data recorder, which comprises cockpit voice recorder 18 and flight data recorder 19, but complement the total system.

Therefore, there is no necessity to collect the data to be stored in the flight data storage modules 1 separately, as a data transfer to the conventional flight data recorders 18, 19 can be recorded, intercepted or tapped by the data collecting device 16. This interception can be carried out interference free such that any influence on the flight data system 17, the cockpit voice recorder 18, and the flight data recorder 19 can be excluded.

The data collected or recorded in this manner may further be communicated to the ejection decision device 13 which takes an ejection decision on this basis according to predetermined criteria and which can control the ejection device 12 as described previously.

Consequently, the flight data storage system 10 can be integrated easily into existing flight data systems without disadvantageous consequences to be expected. It complements hence the conventional systems of flight data recorders and increases the probability of finding the flight data for example after an aircraft accident. The system can be manufactured cost-efficient, in particular because of the cost-efficient design of the flight data memory module 1. It can be integrated cost-efficiently into an existing system with flight data recorders, as no separate data collection is necessary. Further, it reduces the costs of recovery, as the probability for finding the redundant flight data memory modules is significantly increased because of the previously described design with emergency beacon function.

Due to the design of the flight data memory module 1 the data stored in the storage 2 are protected to a large extend from environmental influences and from the effects of an impact. Cause of damage by the flight data memory modules can be excluded. Due to the redundancy of the flight data memory modules it can be expected that at least some of the flight data memory modules 1 can be found promptly and undamaged. In this manner a prompt and economic evaluation of the data and hence of the causes and the circumstances of the accident is possible.

1-12. (canceled)

13. A flight data memory device comprising
a plurality of flight data memory modules, each comprising:
a data memory device for storing data;
a data receiver device for receiving the data; and
a sheath enclosing the data memory device; further comprising
a receptacle for arranging the plurality of flight data memory modules in and/or on an aircraft; and
an ejection device arranged on the receptacle for mechanically ejecting of at least a part of the plurality of flight data memory modules.

14. The flight data memory device according to claim 13, wherein at least a part of the flight data memory modules, is a flight data memory module that has
a total weight of the flight data memory module is less or equal to 200 g.

15. The flight data memory device according to claim 13, wherein at least a part of the flight data memory modules is a flight data memory module for which
the sheath has a maximal diameter of less or equal to 20 cm; and/or
the flight data memory module has a total weight of less or equal to 100 g, and/or
the data memory device has a capacity of less or equal to 512 GB; and/or
the sheath comprises a wall that is formed spherical, ellipsoid, ovoid, rounded convex, from a metal, from a plastic material, and/or at least partially signal-colored.

16. The flight data memory device according to claim 13, wherein at least a part of the flight data memory modules is a flight data memory module for which
the data receiver device is configured to receive the data wirelessly, and/or
the sheath encloses the data receiver device.

17. The flight data memory device according to claim 13, wherein at least a part of the flight data memory modules is a flight data memory module which comprises
a signal sending device for sending a localization signal.

18. The flight data memory device according to claim 13, wherein at least a part of the flight data memory modules is a flight data memory module which comprises
an electric energy storage which is configured to supply electric energy to the data receiver device the data memory device and/or the signal sending device, and
a charging device for wireless or wire bound charging of the electric energy storage with electric energy.

19. A flight data storage system, comprising:
a flight data memory device according to one of claim 13;
a data collecting device for collecting data in a flight data system of the aircraft;
a data transmitting device for transmitting the data collected by the data collecting device to the data receiver device of at least one flight data memory module from the plurality of flight data memory modules.

20. The system according to claim 19, comprising
an ejection decision device for generating an ejection instruction for mechanically ejecting the at least one part of the plurality of flight data memory modules by the ejection device.

21. The system according to claim 19, wherein
the ejection decision device generates the ejection instruction depending on a predetermined ejection criterion, wherein the ejection criterion is evaluated on the basis of at least one information selected from a group comprising
a date collected by the data collecting device,
a trigger request given by an operator,
an information concerning an instable attitude of the aircraft,
an information concerning a failure of a subsystem of the aircraft,
an information concerning a loss of height of the aircraft,
an information concerning an emergency measure initiated by a pilot, copilot or flight attendant, and
further data of the flight data system.

22. The system according to one of claim 19, comprising
an encrypting device for encrypting the data collected by the data collecting device, which are to be transmitted to the data receiver device of the at least one of the plurality of flight data memory modules.

23. A method for storing of flight data comprising
collecting of data in a flight data system of an aircraft;
transmitting the collected data to a data receiver device of at least one flight data memory module from a plurality of flight data memory modules, wherein the flight data memory modules are arranged in an receptacle in and/or on the aircraft; and
mechanically ejecting in response to an ejection instruction depending on a predetermined ejection criterion at least a part of the plurality of flight data memory modules by an ejection device arranged on the receptacle.
